(19) United States
(12) Patent Application Publication
(10) Pub. No.: US 2009/0115213 A1
(43) Pub. Date: May 7, 2009

(54) Apparatus for Removing Undesirable Objects from a Surface

(76) Inventor: Garry W. Charles, Enid, OK (US)

Correspondence Address: JAY M. SCHLOFF;INTELLIPEX PLLC, 30200 TELEGRAPH RD, SUITE 245, BINGHAM FARMS, MI, 48025, US

(21) Appl. No.: 11/934,465

(22) Filed: Nov. 2, 2007

(51) Int. Cl. B25B 9/02

(52) U.S. Cl. 294/99.2

(57) ABSTRACT

Disclosed is an apparatus for removal of an object from a surface. The apparatus includes a first arm and a second arm having a distal end portion and a proximal end portion. The proximal end portion of the first arm and the proximal end portion of the second arm are coupled, thereby enabling the distal end portion of the first arm and the distal end portion of the second arm to be spaced apart and capable of bending towards the space therebetween. The apparatus includes a first scoop extending from the distal end portion of the first arm and a second scoop extending from the distal end portion of the second arm. The first scoop and the second scoop are configured to grip the object upon pressing the first arm and the second arm towards the space therebetween, thereby enabling removal of the object without a user touching the object.

### FIELD OF THE INVENTION

The present invention generally relates to removal of undesirable objects from a surface, and, more particularly, to an apparatus for the removal of undesirable objects from the surface without a user touching the undesirable object.

### BACKGROUND OF THE INVENTION

While involved in indoor and outdoor activities, humans and animals are exposed to undesirable objects. Sometimes, the undesirable objects (for example, stickers, splinters, glass, and the like) get stuck on the exposed skin and clothing of humans and animals and are difficult and unsafe to remove by bare hands. If not removed in time, such undesirable objects may lead to skin problems, for example, rashes, skin infections and the like. In more extreme cases, the undesirable objects may cause bleeding to humans and animals. For example, glass or wood that may accidentally enter human skin, may cause bleeding. Furthermore, the use of bare human hands to remove such undesirable objects may cause harm to humans as well. For example, while removing glass, stickers, splinters, or the like, a human may get hurt.

Further, due to the nature of activities they are involved in, children (as compared to adults) are more vulnerable to being harmed by such undesirable objects. Therefore, it becomes imperative to remove such undesirable objects that cannot safely and easily be removed by bare human hands.

Accordingly, there is a need for an efficient tool that can be easily and conveniently used by humans for the removal of undesirable objects from a surface without any human contact. Moreover, the tool needs to be safe enough to be used by children as well. Further, the tool may need to be used in the absence of light i.e. may be used in an un-illuminated place.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 is a side view of an apparatus suitable for the removal of undesirable objects from a surface, according to an exemplary embodiment of the present invention;

FIG. 2 is a front view of the apparatus of FIG. 1 suitable for the removal of undesirable objects from the surface, according to another exemplary embodiment of the present invention; and

FIGS. 3A, 3B and 3C illustrate different bottom views of the apparatus of FIG. 1 suitable for the removal of undesirable objects from the surface, according to another exemplary embodiment of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting. The terms “a” and “an” herein do not denote a limitation of quantity, but rather denote the presence of at least one of the referenced item.

The present invention provides an apparatus suitable for the removal of objects from a surface. More specifically, the objects are undesirable objects such as splinters, glass, intrusive objects, and the like. Stickers, also known as botanical hitchhikers belonging to Zygophyllaceae Caltrop Family II type plants, are another sort of such undesirable objects. These undesirable objects may attach themselves or cling on to surfaces, examples of which include but are not limited to, human skin, pets, clothing, and other delicate surfaces. The apparatus includes a pair of arms connected at proximal ends and spaced apart at distal ends of the pair of arms. The pair of arms is capable of being bent towards a space between the distal ends of the pair of arms thereby enabling the apparatus to grip the undesirable object securely and removing the undesirable object from the surface without a user touching the undesirable object.

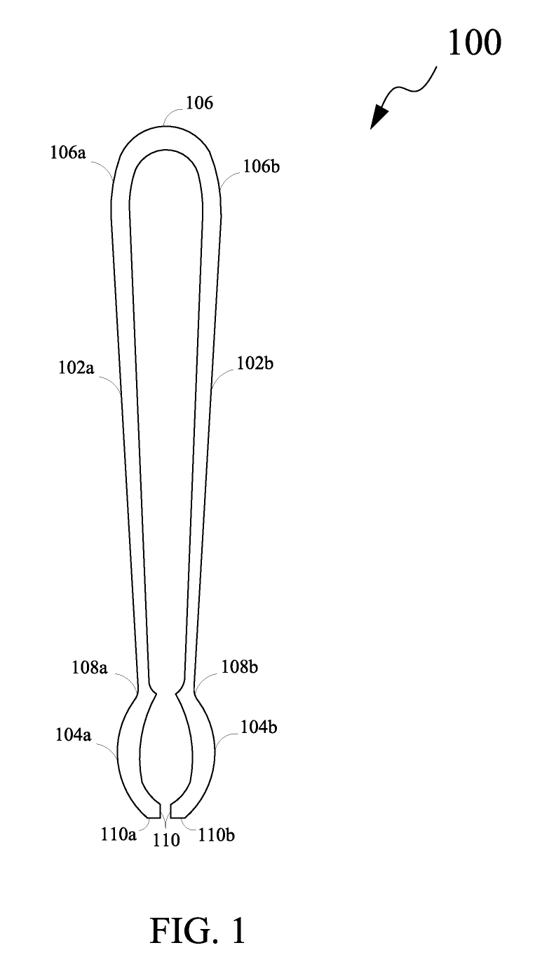

FIG. 1 is a side view of an apparatus 100 suitable for the removal of undesirable objects from a surface, according to an exemplary embodiment of the present invention. The apparatus 100 includes a first arm 102a, a second arm 102b, a first scoop 104a and a second scoop 104b. In an embodiment, the apparatus 100 may also include a light source. Light provided by the light source enables the apparatus 100 to be used for the removal of the undesirable objects in places with low illumination or where light is absent.

As shown in the side view, the first arm 102a and the second arm 102b (hereinafter collectively referred to as ‘arms 102’) of the apparatus 100 have a proximal end portion and a distal end portion. A proximal end portion 106a of the first arm 102a is coupled to a proximal end portion 106b of the second arm 102b at a proximal end 106 of the apparatus 100. The coupling enables a distal end portion 108a of the first arm 102a and a distal end portion 108b of the second arm 102b to be spaced apart and capable of being bent towards a space between the distal end portion 108a of the first arm 102a and the distal end portion 108b of the second arm 102b (hereinafter collectively called as ‘distal ends 108’). In one specific configuration of the apparatus 100, the arms 102 may be spaced apart by about 0.5 inch. However, it will be apparent to a person ordinarily skilled in the art that the spacing may vary based on other dimensions and application of the apparatus 100. In an embodiment, the apparatus 100 may be made of plastic material. Additionally, the apparatus 100 may be made of a photoluminescent material. The arms 102 may be coupled at the proximal end 106 of the apparatus 100 using suitable fastening mechanisms. The suitable fastening mechanism may include but is not limited to a nut and bolt arrangement, welding, and the like. The distal end portion 108a of the first arm 102a extends to form the first scoop 104a. Similarly, the distal end portion 108b of the second arm 102b extends to form the second scoop 104b. The first scoop 104a includes a short, protruded portion extending from the distal portion 108a and towards the space between the arms 102 to form a tip bite 110a, as shown in FIG. 1. Similarly, the second scoop 104b includes a short, protruded portion extending from the distal end portion 108b and towards the space between the arms 102 to form a tip bite 110b, as shown in FIG. 1 Hereinafter, the tip bite 110a and the tip bite 110b will collectively be referred to as ‘tip bite 110.’ The first scoop 104a and the second scoop 104b together configure a circular portion creating a space therebetween for gripping the undesirable object securely from the surface.

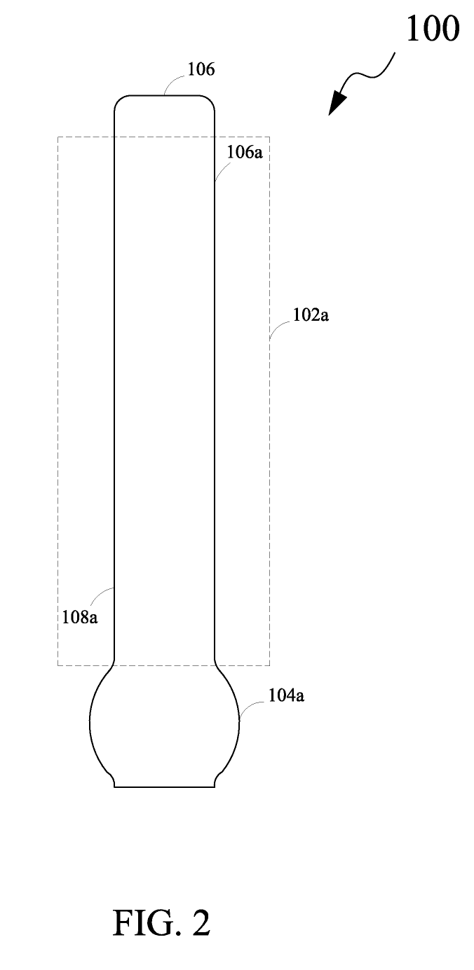

FIG. 2 is a front view of the apparatus 100 of FIG. 1 suitable for the removal of the objects from the surface, according to another exemplary embodiment of the present invention. For the purpose of description of FIG. 2, reference will be made to elements of the apparatus 100 described in FIG. 1 above. In the front view, the first arm 102a is visible along with the components associated with the first arm 102a. In an embodiment of the present invention, length of the apparatus 100 may be from about 3.5 inches to about 4.0 inches. However, it will be apparent to a person ordinarily skilled in the art that the length of the apparatus 100 is not restricted and may vary depending on area of application of the apparatus 100.

Further, the first scoop 104a and the second scoop 104b (hereinafter collectively referred to as ‘scoop 104’) are configured in a manner such that upon pressing the distal end portion 108a and the distal end portion 108b towards the space therebetween, enables the first scoop 104a in combination with the second scoop 104b to grip the undesirable object securely. This enables removal of the undesirable object without a user touching the undesirable object. The tip bite 110 extending from the scoop 104 are used to grip over stickers and other undesirable objects that need to be removed. The apparatus 100 is held from the arms 102. The arms 102 are held like tweezers or small tongs. When an inward pressure is applied at the arms 102 of the apparatus 100 towards the space between the distal end portion 108a and the distal end portion 108b, the object gets enclosed within the scoop 104, and the tip bite 110 securely grip the object, for example a sticker, for easy removal.

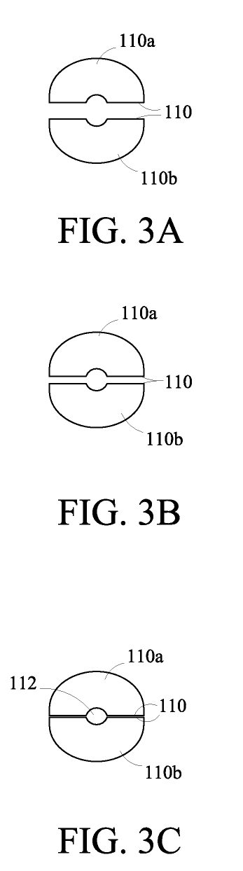

FIGS. 3A, 3B and 3C represent different bottom views of the apparatus 100 of FIGS. 1 and 2 suitable for the removal of the undesirable objects from the surface, according to yet another exemplary embodiment of the present invention. For the purpose of description of this figure, reference will be made to the elements of the apparatus 100 introduced in the FIGS. 1 and 2 above. FIGS. 3A and 3B depict open positions of the tip bite 110a and the tip bite 110b that are formed by the protruded portions present on the scoop 104. FIG. 3A represents a fully open position of the scoop 104 when the apparatus 100 is not in use. The tip bite 110, as shown in the FIG. 3, are spaced apart sufficiently for gripping the undesirable objects to be removed from the surface, for example clothing. The undesirable objects may attach themselves, or cling to the surface while walking or working outdoors such as in open fields.

FIG. 3B depicts a partially closed position of the tip bite 110 when a pressure is applied to the arms 102 to grip the undesirable object. The undesirable object that has been gripped may be held within the scoop 104 and may be safely removed and disposed.

FIG. 3C depicts a fully closed position of the tip bite 110 when the scoop 104 is joined by pressing. The fully closed position with the tip bite 110 joined together appears substantially as a circle with a central hole formed therein. It will be apparent to a person ordinarily skilled in the art that the tip bite 110 may exist in another embodiment without the semi circular hole.

As explained, the apparatus of the present invention is beneficial for removing undesirable objects, such as stickers, splinters, glass, and the like, from the surface of skin, clothing and the like. The apparatus does not require the user to utilize fingers to enable removal of the undesirable objects. Due to the simplicity of construction and usage of the apparatus, the apparatus may be used by adults as well as children. The apparatus may be packaged in attractive forms for children, such as with a photoluminescent material, so that the apparatus may glow in the dark. For the same purpose, the apparatus may also be available with a light source that may be used in the absence of light. The apparatus finds usage by a range of people belonging to various fields, such as the medical field, military forces, sports, wildlife, hunters, teachers, coaches, scouting groups, woodworkers, and the like. The apparatus, generally made of plastic, is simple, light weight and cheap to manufacture.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omissions and substitutions of equivalents are contemplated as circumstance may suggest or render expedient, but such omissions and substitutions are intended to cover the application or implementation without departing from the spirit or scope of the claims of the present invention.

1. A pair of tongs for removal of an object from a surface, the pair of tongs comprising:
a first arm and a second arm, wherein the first arm and the second arm having a distal end portion and a proximal end portion, the proximal end portion of the first arm coupled to the proximal end portion of the second arm for configuring a curved portion there between for enabling the distal end portion of the first arm and the distal end portion of the second arm to be spaced apart and capable of being bent towards a space between the distal end portion of the first arm and the distal end portion of the second arm;
a first scoop extending from the distal end portion of the first arm; and
a second scoop extending from the distal end portion of the second arm,
wherein the first scoop and the second scoop are configured in a manner such that upon pressing the distal end portion of the first arm and the distal end portion of the second arm towards the space therebetween enables the first scoop in combination with the second scoop to grip the object securely and thereby enabling removing the object without a user touching the object.

2. The pair of tongs of claim 1, wherein a material of the the pair of tongs is plastic.

3. The pair of tongs of claim 2, wherein the material is photoluminescent.

4-6. (canceled)

7. The pair of tongs of claim 1, wherein each of the first scoop and the second scoop comprises a tip bite, and wherein the tip bite of each of the first scoop and the second scoop combine together to configure an opening there between.
